(19) United States
(12) Patent Application Publication
(10) Pub. No.: US 2021/0362185 A1
(43) Pub. Date: Nov. 25, 2021

(54) Front and Back Spot Gluing and Solidifying Machine for Earphone MLB Parts

(71) Applicant: Innovation Sound Technology Co., Ltd., Shenzhen, Guangdong (CN)

(72) Inventors: Shun Ming Yuen, Shenzhen, Guangdong (CN); Qingshan Tang, Shenzhen, Guangdong (CN); Feng Xiong, Shenzhen, Guangdong (CN)

(21) Appl. No.: 17/256,229

(22) PCT Filed: Nov. 11, 2019
(86) PCT No.: PCT/CN2019/117125

§ 371 Date: Dec. 27, 2020

(30) Foreign Application Priority Data
Nov. 8, 2019 (CN) 201911085469.9

(51) Int. Cl. B05D 3/06; H04R 1/10

(52) U.S. Cl. CPC B05D 3/067; H04R 1/1058

(57) ABSTRACT

The invention discloses a front and back spot gluing and solidifying machine for earphone MLB parts, which consists of two sets of racks, opposite sensors set on each belt module, a gluing module disposed above the belt module, a height measurement system placed on the gluing module, and a CCD system set above the gluing module. The invention realizes fully automatic product delivery, automatic UV solidification on the front, automatic turnover, and gluing and solidification on the back, with high efficiency.

### FIELD OF THE INVENTION

The invention relates to the technical field of fully automatic equipment for front UV solidification, and back spot gluing and UV solidification of MLB parts, and in particular to a front and back spot gluing and solidifying machine for earphone MLB parts.

### BACKGROUND OF THE INVENTION

Traditional front solidification, and back spot gluing and UV solidification of MLB parts is mainly done by manual operation, which features low efficiency and high costs of manual labor. Moreover, the manual operation is prone to deviations, resulting in inaccurate control of the amount of glue, poor UV solidification, poor gluing quality, and a low rate of finished products.

Traditional UV solidification requires manual operation, which may lead to severe burns to eyes and skin caused by ultraviolet radiation because UV light cannot be completely sealed.

### DESCRIPTION OF THE INVENTION

The technical problem to be solved by the present invention is to overcome the existing defects by providing a front and back spot gluing and solidifying machine for earphone MLB parts. By setting up independent two-section belts for feeding, the sensitive sensor controls the movement of the product so that the entire movement process does not produce overlapping materials or collisions between two products. The UV lamp starts glowing for solidification when the enclosure is completely closed, and the back side is turned through the turnover module to realize the spot gluing and solidification from the front to the back, thus achieving fully automatic feeding for products, fully automatic solidification, fully automatic turnover, and fully automatic spot gluing and solidification. The machine has high degree of automation, high positioning accuracy, high work efficiency, good product effect, and low production cost. Being convenient, simple and fast in use, it can effectively solve the problems in the background technology.

In order to solve the above technical problems, the present invention provides the following technical solutions:

The present invention provides a front and back spot gluing and solidifying machine for earphone MLB parts, consisting of:

No. 1 rack and No. 2 rack; and

No. 1 belt module disposed on No. 1 rack; and

No. 2 belt module disposed on No. 2 rack; and

No. 1 block module disposed on No. 1 rack; and

No. 2 block module disposed on No. 1 rack; and

No. 1 UV module disposed on No. 1 rack; and

A turnover module disposed on No. 1 rack; and

No. 4 block module disposed on No. 2 rack; and

No. 3 block module disposed on No. 2 rack; and

No. 4 block module disposed on No. 2 rack; and

A gluing module disposed on No. 2 rack; and

No. 2 UV module disposed on No. 2 rack; and

No. 14 and No. 1 sensors disposed on No. 1 belt module to activate the first belt; and

No. 13 sensor disposed on No. 1 belt module to reset No. 1 block module; and

No. 12 sensor disposed on No. 1 belt module to sense UV solidification (1) in place; and

No. 11 sensor disposed on No. 1 belt module to reset No. 2 block module; and

No. 10 sensor disposed on No. 1 belt module to sense the presence of materials on turnover; and

No. 9 sensor disposed on No. 2 belt module to sense the turnover in place; and

No. 8 sensor disposed on No. 2 belt module to determine whether it can be turned; and

No. 7 sensor disposed on No. 2 belt module to activate the second belt; and

No. 6 sensor disposed on No. 2 belt module to reset No. 4 block module; and

No. 5 sensor for gluing materials disposed on No. 2 belt module; and

No. 4 sensor disposed on No. 2 belt module to reset No. 3 block module; and

No. 3 sensor disposed on No. 2 belt module to sense UV solidification (2) in place; and

No. 2 sensor disposed on No. 2 belt module to reset No. 4 block module; and

No. 1 sensor disposed on the rear of No. 2 belt module.

As a preferred technical solution of the present invention, the front and back spot gluing and solidifying machine for earphone MLB parts also includes:

No. 1 enclosure disposed on No. 1 rack; and

No. 2 enclosure disposed on No. 2 rack.

As a preferred technical solution of the present invention, the No. 1 belt module is connected to No. 1 motor, which provides power for No. 1 belt module.

As a preferred technical solution of the present invention, the No. 1 UV module includes:

No. 1 sealed cover;

No. 1 front sealed door, disposed on one side of the No. 1 sealed cover;

No. 1 rear sealed door, disposed on the other side of the No. 1 sealed cover;

Wherein the No. 1 front sealed door and No. 1 rear sealed door are respectively connected with a cylinder, which provides power for opening and closing doors.

As a preferred technical solution of the present invention, the turnover module includes:

No. 2 motor, disposed in the upper part of the No. 1 rack;

The clamping mechanism module, to which the No. 2 motor is connected.

As a preferred technical solution of the present invention, the gluing module includes:

A straightening press module, disposed in the upper part of the No. 2 rack;

A syringe module, disposed on one side of the straightening press module;

A residual glue-erasing module, disposed on one side of the syringe module;

A spot gluing positioning module, disposed on one side of the residual glue-erasing module;

A height measurement system, used to measure the height of the product;

A CCD system for measuring the position of the product;

A three-axis spot gluing rack, set on one side of the spot gluing positioning module.

As a preferred technical solution of the present invention, the No. 2 UV module includes:

No. 2 sealed cover, disposed on the upper part of the No. 2 rack;

No. 2 front sealed door, disposed on one side of the No. 2 sealed cover;

No. 2 rear sealed door, disposed on the other side of the No. 2 sealed cover;

Wherein the No. 2 front sealed door and No. 2 rear sealed door are respectively connected with a cylinder, which provides power for opening and closing doors.

As a preferred technical solution of the present invention, the front and back spot gluing and solidifying machine for earphone MLB parts further includes:

No. 1 fan disposed on the No. 1 rack and used for exhaust cooling, and a compressed gas switch valve for controlling gas discharge;

No. 2 fan disposed on the No. 2 rack and used for exhaust cooling, and a compressed gas switch valve for controlling gas discharge.

As a preferred technical solution of the present invention, the front and back spot gluing and solidifying machine for earphone MLB parts further includes:

No. 2 man-machine interface disposed on the No. 1 enclosure:

No. 1 man-machine interface disposed on the No. 2 enclosure.

One or a plurality of technical solutions provided in the present invention has at least the following technical effects or advantages:

By setting up independent two-section belts for feeding, the sensitive sensor controls the movement of the product so that the entire movement process does not produce overlapping materials or collisions between two products. The UV lamp starts glowing for solidification when the enclosure is completely closed, and the back side is turned through the turnover module to realize the spot gluing and solidification from the front to the back, thus achieving fully automatic feeding for products, fully automatic solidification, fully automatic turnover, and fully automatic spot gluing and solidification. The machine has high degree of automation, high positioning accuracy, high work efficiency, good product effect, and low production cost, being convenient, simple and fast in use.

### BRIEF INTRODUCTION OF THE DRAWINGS

The accompanying drawings are used to provide a further understanding of the present invention, and constitute a part of the specification. Together with the embodiments of the present invention, they are used to explain the present invention but shall not constitute a limitation to the present invention.

In the accompanying drawings:

FIG. 1-FIG. 3 are three-dimensional views of a front and back spot gluing and solidifying machine for earphone MLB parts according to an embodiment of the present invention;

FIG. 4-FIG. 7 are three-dimensional views of internal structure of a front and back spot gluing and solidifying machine for earphone MLB parts according to an embodiment of the present invention;

FIG. 8-FIG. 25 are enlarged schematic diagrams of the upper part A-R of a front and back spot gluing and solidifying machine for earphone MLB parts according to an embodiment of the present invention;

Numbers in the figures: No. 1 rack 10, No. 2 rack 112, No. 1 enclosure 110, No. 2 enclosure 111, No. 1 belt module 317, No. 2 belt module 30, No. 1 block module 12, No. 2 block module 13, No. 1 UV module 50, turnover module 60, No. 4 block module 15, No. 2 rack 112, No. 3 block module 16, No. 4 block module 17, gluing module 20, No. 2 UV module 40, No. 1 belt module 317, No. 14 and No. 1 sensors 314, No. 1 belt module 317, No. 13 sensor 313, No. 12 sensor 312, No. 11 sensor 311, No. 10 sensor 310, No. 2 belt module 30, No. 9 sensor 39, No. 8 sensor 38, No. 7 sensor 37, No. 6 sensor 36, No. 5 sensor 35, No. 4 sensor 34, No. 3 sensor 33, No. 2 sensor 32, No. 1 sensor 31, No. 1 motor 315, No. 1 front sealed door 53, No. 1 sealed cover 52, No. 1 rear sealed door 51, No. 2 motor 61, clamping mechanism module 62, No. 3 motor 316, straightening press module 21, syringe module 22, residual glue-erasing module 23, spot gluing positioning module 24, height measurement system 25, CCD system 26, three-axis spot gluing rack 27.

No. 2 front sealed door 43, No. 2 sealed cover 42, No. 2 rear sealed door 41, No. 1 fan 18, switch valve 11, No. 2 fan 14, switch valve 19, No. 2 man-machine interface 114, No. 1 man-machine interface 113.

### Detailed Description of the Preferred Embodiments

In order to make the objectives, technical solutions and advantages of the present invention clearer, further descriptions are presented below on the invention in detail with reference to the accompanying drawings and embodiments. It shall be understood that the specific embodiments described herein are only used to interpret the present invention, but not to limit the present invention.

In the description of the present invention, it shall be understood that the orientation or positional relationship indicated by the terms such as “length”, “width”, “upper”, “lower”, “front”, “rear”, “left”, “right”, “vertical”, “horizontal”, “top”, “bottom”, “inside”, “outside” are based on the orientation or positional relationship shown in the drawings, which are only for the convenience of describing the present invention and simplifying the description, rather than indicate or imply that the specified device or element must have a specific orientation, or must be constructed and operated in a specific orientation. Therefore, it shall not be understood as a limitation on the present invention. Moreover, in the description of the present invention, “a plurality of” means two or more than two, unless otherwise specifically defined.

To better understand the above technical solutions, the above technical solutions will be described in detail below in conjunction with the drawings to the specification and specific implementations.

### Embodiments

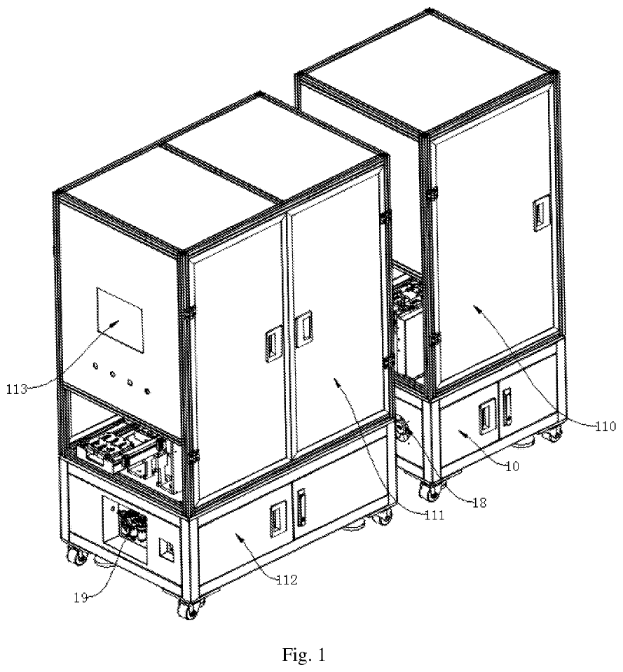

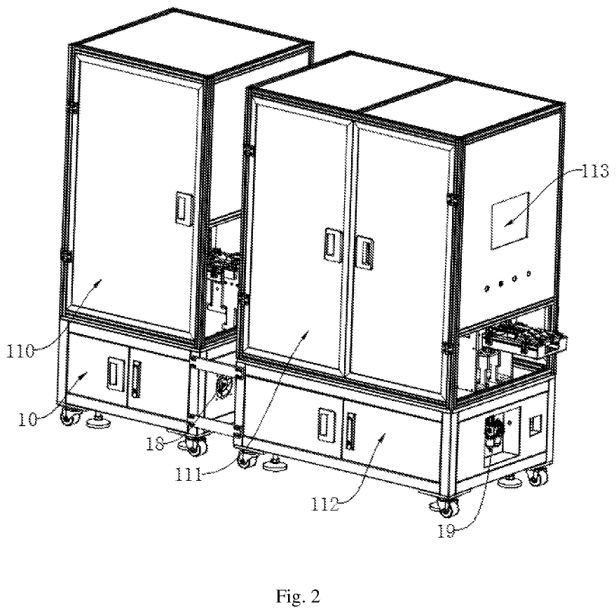

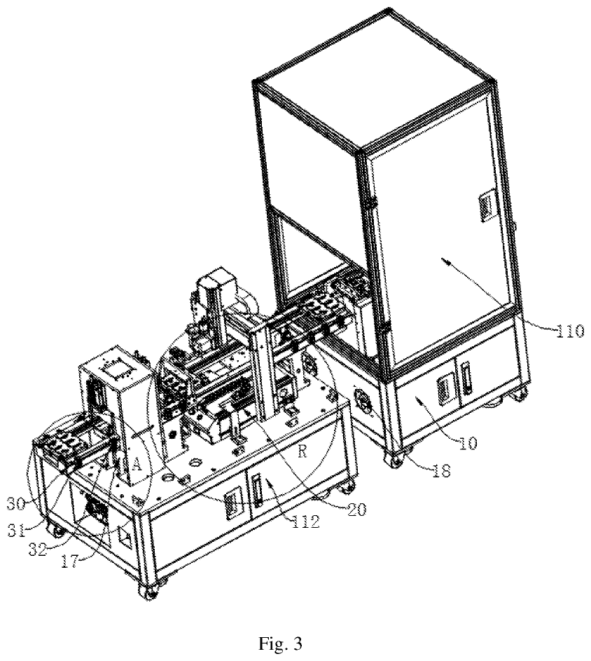

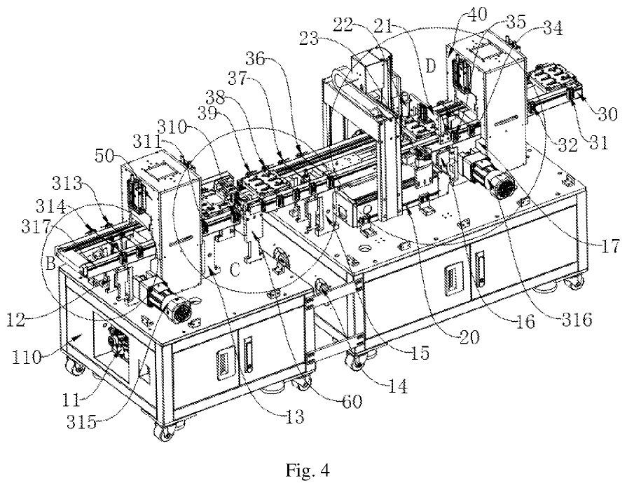

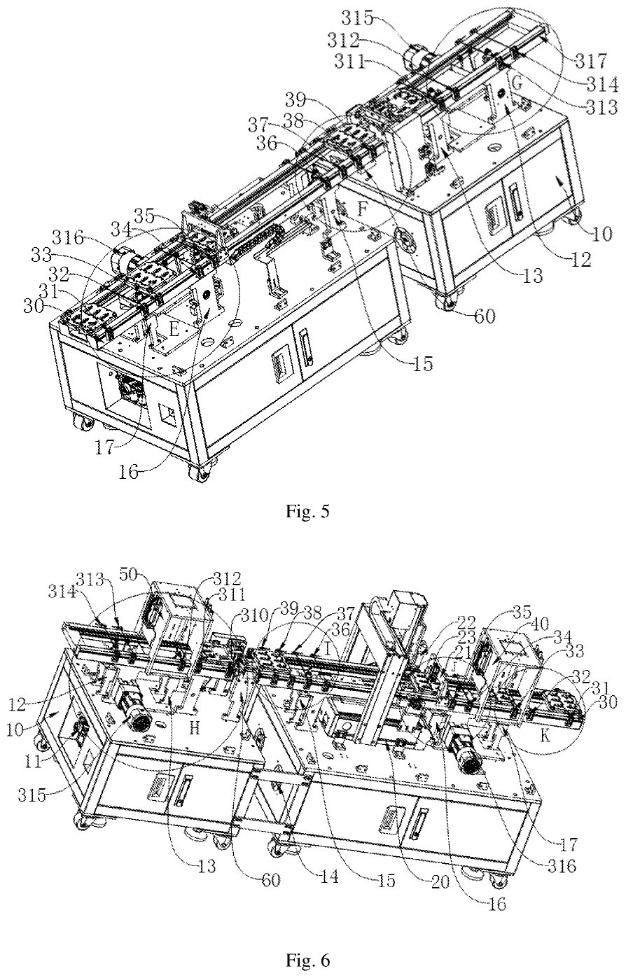

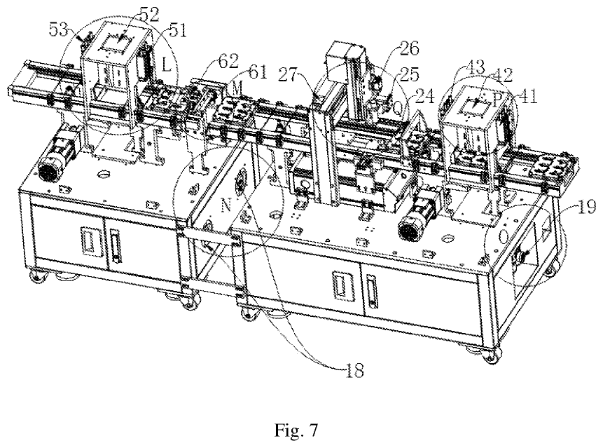

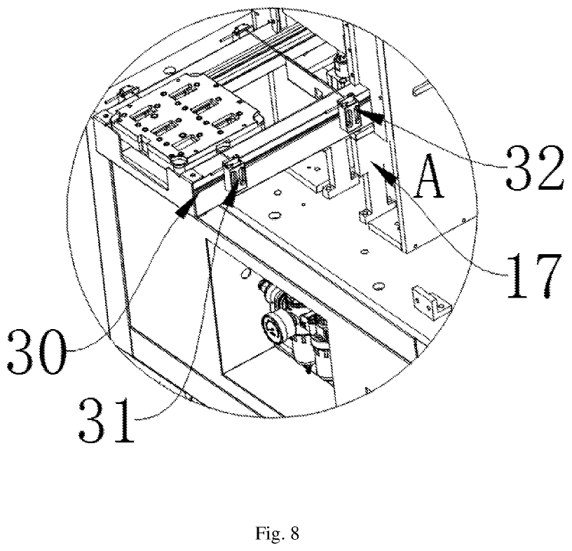

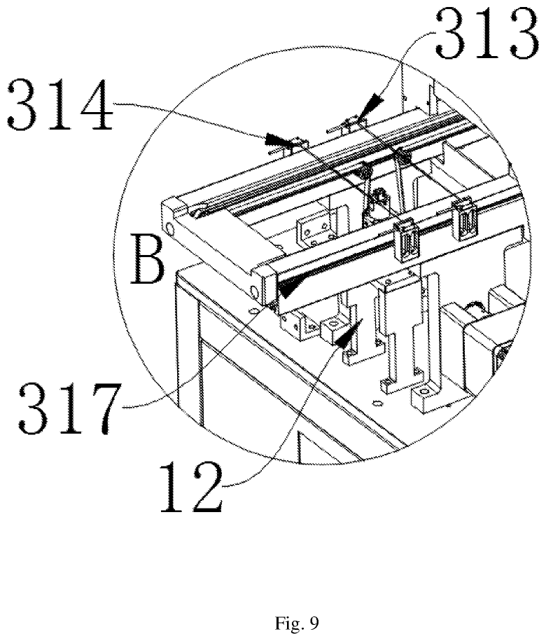

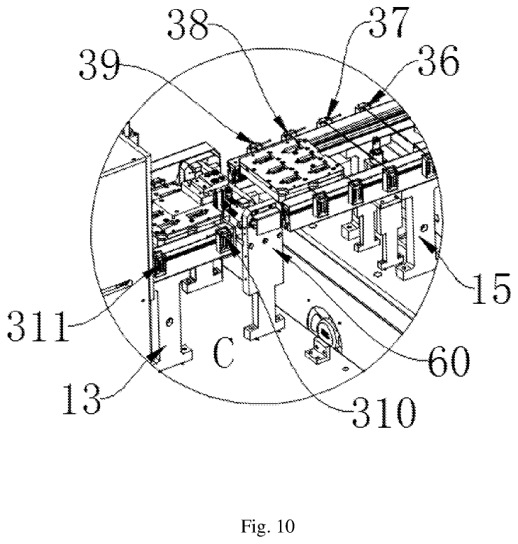

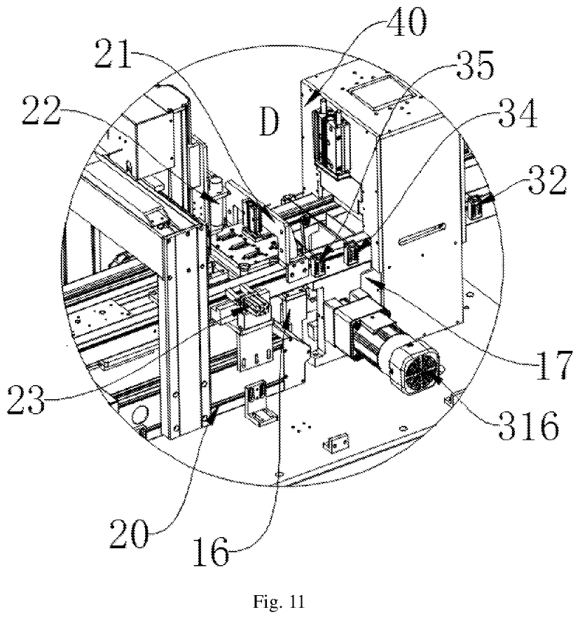

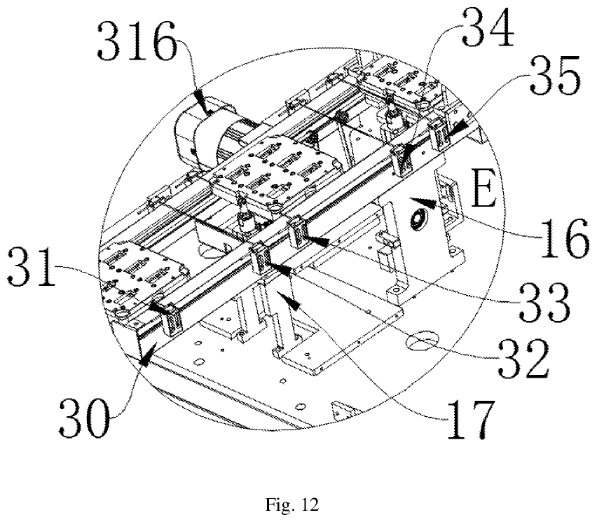

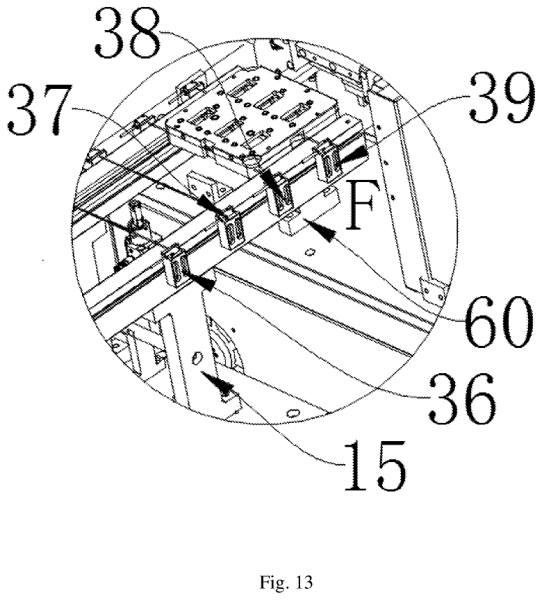

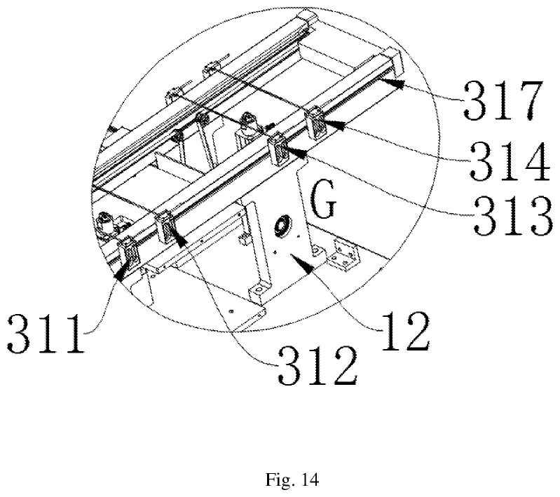

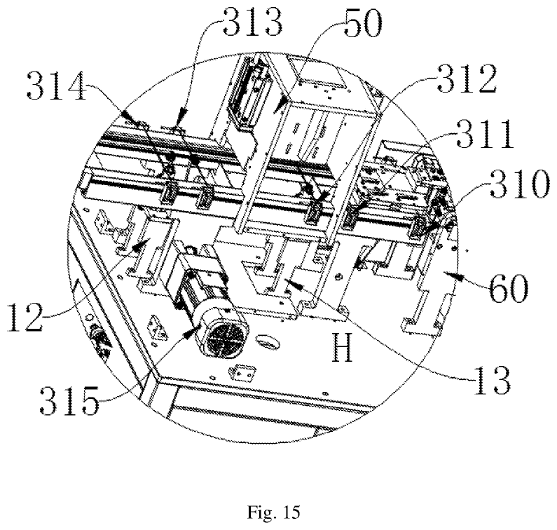

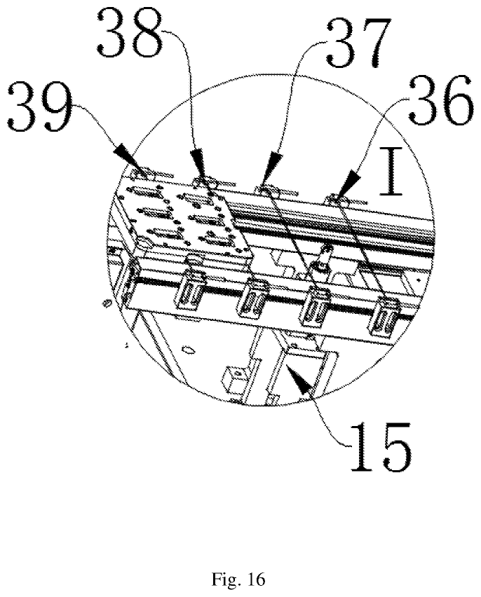

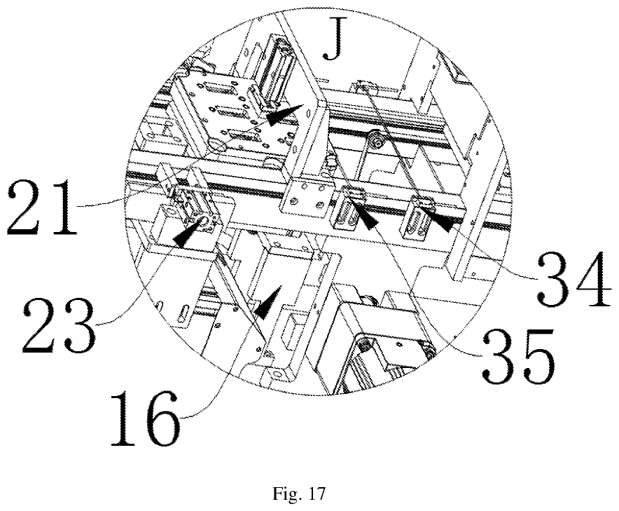

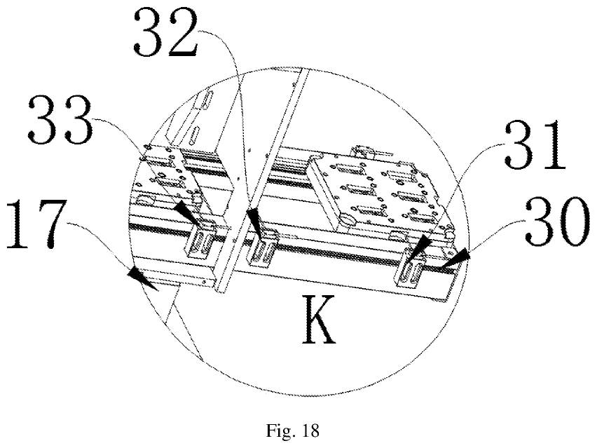

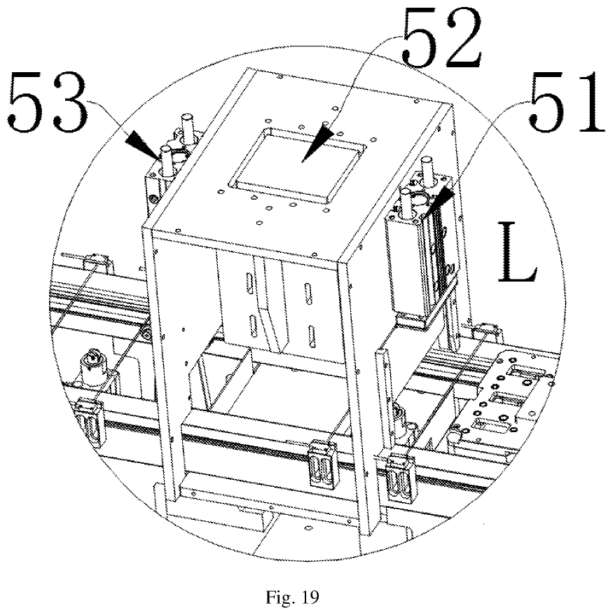

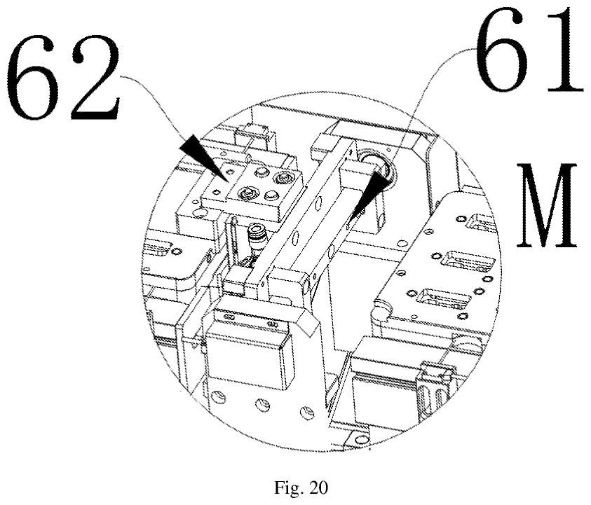

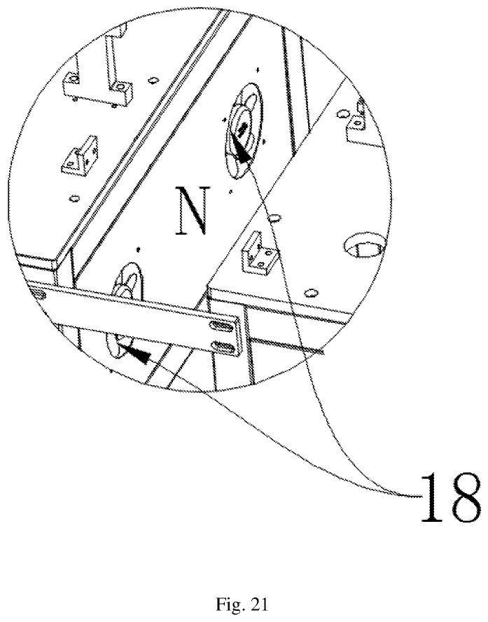

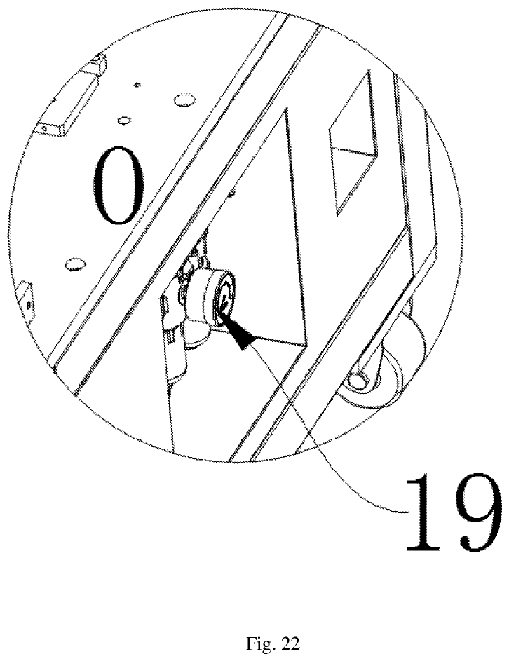

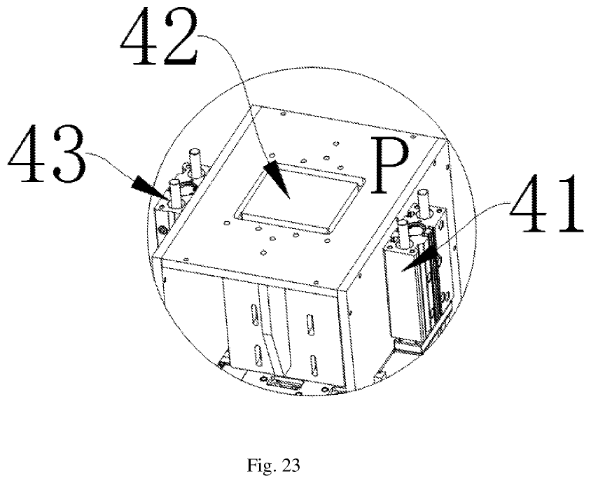

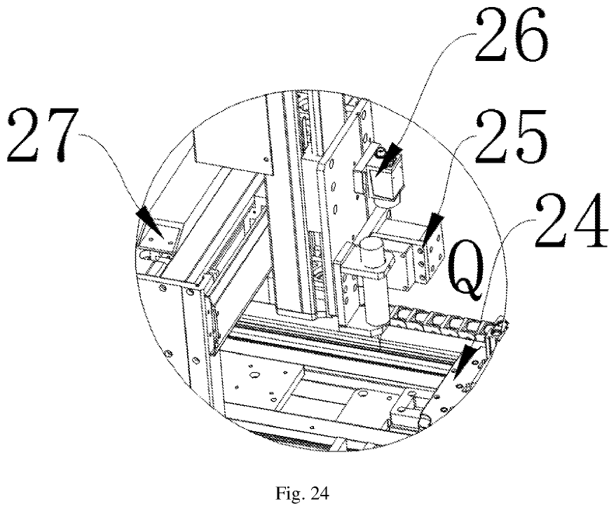

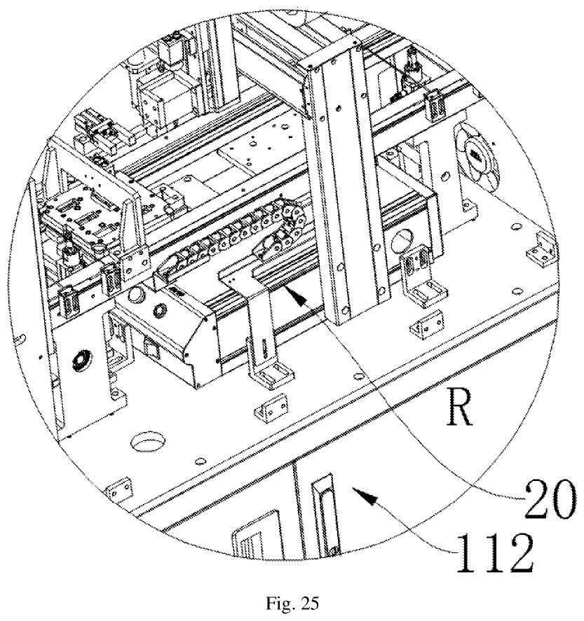

With reference to FIG. 1-25, the present invention discloses a front and back spot gluing and solidifying machine for earphone MLB parts, consisting of:

No. 1 rack 10 and No. 2 rack 112; and No. 1 enclosure (110) disposed on No. 1 rack (10); and No. 2 enclosure (111) disposed on No. 2 rack (112); and No. 1 belt module 317 disposed on No. 1 rack 10; and No. 2 belt module 30 disposed on No. 2 rack 112; and No. 1 block module 12 disposed on No. 1 rack 10; and No. 2 block module 13 disposed on No. 1 rack 10; and No. 1 UV module 50 disposed on No. 1 rack 10; and a turnover module 60 disposed on No. 1 rack 10; and No. 4 block module 15 disposed on No. 2 rack 112; and No. 3 block module 16 disposed on No. 2 rack 112; and No. 4 block module 17 disposed on No. 2 rack 112; and a gluing module 20 disposed on No. 2 rack 112; and No. 2 UV module 40 disposed on No. 2 rack 112; and No. 14 and No. 1 sensors 314 disposed on No. 1 belt module 317 to activate the first belt; and No. 13 sensor 313 disposed on No. 1 belt module 317 to reset No. 1 block module 12; and No. 12 sensor 312 disposed on No. 1 belt module 317 to sense UV solidification (1) in place; and No. 11 sensor 311 disposed on No. 1 belt module 317 to reset No. 2 block module 13; and No. 10 sensor 310 disposed on No. 1 belt module 317 to sense the presence of materials on turnover; and No. 9 sensor 39 disposed on No. 2 belt module 30 to sense the turnover in place; and No. 8 sensor 38 disposed on No. 2 belt module 30 to determine whether it can be turned; and No. 7 sensor 37 disposed on No. 2 belt module 30 to activate the second belt; and No. 6 sensor 36 disposed on No. 2 belt module 30 to reset No. 4 block module 15; and No. 5 sensor 35 for gluing materials disposed on No. 2 belt module 30; and No. 4 sensor 34 disposed on No. 2 belt module 30 to reset No. 3 block module 16; and No. 3 sensor 33 disposed on No. 2 belt module 30 to sense UV solidification (2) in place; and No. 2 sensor 32 disposed on No. 2 belt module 30 to reset No. 4 block module 17; and No. 1 sensor 31 disposed on the rear of No. 2 belt module 30.

Wherein the No. 1 belt module 317 is connected to No. 1 motor 315, which provides power for No. 1 belt module 317.

Wherein the No. 1 UV module 50 includes No. 1 front sealed door 53, No. 1 sealed cover 52, and No. 1 rear sealed door 51. The front and rear sealed doors are respectively connected with a cylinder, which provides power for opening and closing doors.

Wherein the turnover module 60 includes No. 2 motor 61 and a clamping mechanism module 62.

Wherein the No. 2 belt module 30 is connected to No. 3 motor 316, which provides power for No. 2 belt module 30.

Wherein the glue module 20 includes a straightening press module 21, a syringe module 22, a residual glue-erasing module 23, a spot gluing positioning module 24, a height measurement system 25, a CCD system 26, and a three-axis spot gluing rack 27.

Wherein the No. 2 UV module 40 includes No. 2 front sealed door 43, No. 2 sealed cover 42, and No. 2 rear sealed door 41. The front and rear sealed doors are respectively connected with a cylinder, which provides power for opening and closing doors.

Wherein the No. 1 rack 10 is equipped with No. 1 fan 18 for exhaust cooling, and a compressed gas switch valve 11.

Wherein the No. 2 rack 112 is equipped with No. 2 fan 14 for exhaust cooling, and a compressed gas switch valve 19.

Wherein No. 2 man-machine interface 114 is installed on the No. 1 enclosure 110.

Wherein No. 1 man-machine interface 113 is installed on the No. 2 enclosure 111.

During operation, first set relevant parameters on No. 2 man-machine interface 114 and No. 1 man-machine interface 113. Put in the products to be solidified and glued. When other sensors detect that there is no object but No. 14 and No. 1 sensors 314 detect that there is an object, start the first belt line 317, and No. 1 block module 12 is released. The product moves forward, and the No. 1 block module 12 will be reset immediately when the trailing edge of No. 13 sensor 313 detects it. The product keeps moving forward. When an object triggers No. 12 sensor 312, No. 1 front sealed door 53 and No. 1 rear sealed door 51 in No. 1 UV module 50 are activated. The No. 1 sealed cover 52 closes down, and the product begins to be solidified. After solidification, No. 1 front sealed door 53 and No. 1 rear sealed door 51 in No. 1 UV module 50 are reset, and No. 2 block module 13 is released. The product moves forward, and the No. 2 block module 13 will be reset immediately when the trailing edge of No. 11 sensor 311 detects it. The product keeps moving forward. When an object triggers No. 10 sensor 310, the tightening mechanism 62 of the turnover module 60 clamps. If the No. 8 sensor 38 detects no object, the No. 2 motor 61 drives the clamping mechanism 62 to turn 180 degrees.

When the No. 9 sensor 39 is triggered, the clamping mechanism 62 is released and the product moves forward. When the No. 7 sensor 37 is triggered, the side turning mechanism 62 is reset, and the No. 4 block module 15 is released. When the trailing edge of No. 6 sensor 36 detects a product, No. 4 block module 15 is reset immediately. The product keeps moving forward. When an object triggers No. 5 sensor 35, the spot gluing positioning module 24 activates. After positioning, the straightening press module 21 activates. After the action, the straightening press module 21 is reset. The three-axis spot gluing rack 27 starts to move, and the height measurement system 25 and the CCD system 26 start to identify the position and height of the product. When the data is collected, the syringe module 22 starts gluing. After spot gluing is done, the syringe module 22 wipes the glue on the needle at the residual glue-erasing module 23, the spot gluing positioning module 24 is reset, and the No. 3 block module 16 is released. The product keeps moving forward. The No. 3 block module 16 is reset immediately when the trailing edge of No. 4 sensor 34 detects a product. The product keeps moving forward. When an object triggers No. 3 sensor 33, No. 2 front sealed door 43 and No. 2 rear sealed door 41 in No. 2 UV module 40 are activated. The No. 2 sealed cover 42 closes down, and the product begins to be solidified. After solidification, No. 2 front sealed door 43 and No. 2 rear sealed door 41 in No. 2 UV module 40 are reset; No. 4 block module 17 is released; and the product goes forward. The No. 4 block module 17 is reset immediately when the trailing edge of No. 2 sensor 32 detects a product. The product keeps moving forward. When an object triggers No. 1 sensor 31, it informs the operator that the solidification of the front side of the product, and the gluing and solidification of the back side are completed. The whole process automatically completes the conveying, positioning and solidification of objects that require solidification, spot gluing, and UV light sealing, without manual operation. The machine possesses high positioning accuracy, accurate UV solidification time, good glue volume control, precise gluing quality control, high automation, high work efficiency, good finished product effect, and high rates of finished products.

For repeated placement of products, the principle of action is the same as the above process. Hence, it is necessary to repeat.

Finally, it shall be noted that the above descriptions are only preferred embodiments of the present invention, and are not intended to limit the present invention. Although the present invention has been described in detail with reference to the foregoing embodiments, those skilled in the art may still modify the technical solutions described in the foregoing embodiments, or equivalently replace some of the technical features. Any modification, equivalent replacement, improvement, etc., made within the spirit and principle of the present invention shall be included in the protection scope of the present invention.

What is claimed is:

1. A front and back spot gluing and solidifying machine for earphone MLB parts, wherein it consists of:
No. 1 rack (10) and No. 2 rack (112); and
No. 1 belt module (317) disposed on No. 1 rack (10); and
No. 2 belt module (30) disposed on No. 2 rack (112); and
No. 1 block module (12) set on No. 1 rack (10); and
No. 2 block module (13) set on No. 1 rack (10); and
No. 1 UV module (50) set on No. 1 rack (10); and
a turnover module (60) set on No. 1 rack (10); and
No. 4 block module (15) arranged on No. 2 rack (112); and
No. 3 block module (16) arranged on the No. 2 rack (112); and
No. 4 block module (17) arranged on No. 2 rack (112); and
a gluing module (20) arranged on No. 2 rack (112);
No. 2 UV module (40) mounted on No. 2 rack (112); and
No. 14 and No. 1 sensors (314) mounted on No. 1 belt module (317) for starting the first belt; and
No. 13 sensor (313) fixed on No. 1 belt module (317) for resetting of No. 1 block module (12); and
No. 12 sensor (312) fixed on No. 1 belt module (317) to sense UV solidification (1) in place; and
No. 11 sensor (311) set on No. 1 belt module (317) to reset No. 2 block module (13); and
No. 10 sensor (310) set on No. 1 belt module (317) to sense the presence of material on turnover; and
No. 9 sensor (39) set on No. 2 belt module (30) to sense the turnover in place; and
No. 8 sensor (38) set on No. 2 belt module (30) to determine whether it can be turned over; and
No. 7 sensor (37) set on No. 2 belt module (30) to start the second belt; and
No. 6 sensor (36) set on No. 2 belt module (30) to reset No. 4 block module (15); and
No. 5 sensor (35) for gluing materials set on No. 2 belt module (30); and
No. 4 sensor (34) set on No. 2 belt module (30) to reset No. 3 block module (16); and
No. 3 sensor (33) disposed on No. 2 belt module (30) to sense UV solidification (2) in place; and
No. 2 sensor (32) disposed on No. 2 belt module (30) to reset No. 4 block module (17); and
No. 1 sensor (31) fixed on the rear of No. 2 belt module (30).

2. A front and back spot gluing and solidifying machine for earphone MLB parts according to claim 1, wherein it further comprises:
No. 1 enclosure (110) disposed on No. 1 rack (10); and
No. 2 enclosure (111) disposed on No. 2 rack (112).

3. A front and back spot gluing and solidifying machine for earphone MLB parts according to claim 2, wherein the No. 1 belt module (317) is connected to No. 1 motor (315), and No. 1 motor (315) provides power for No. 1 belt Module (317).

4. A front and back spot gluing and solidifying machine for earphone MLB parts according to claim 3, wherein the No. 1 UV module (50) includes:
No. 1 sealed cover (52);
No. 1 front sealed door (53), disposed on one side of No. 1 sealed cover (52);
No. 1 rear sealed door (51), disposed on the other side of No. 1 sealed cover (52);
wherein the No. 1 front sealed door (53) and the No. 1 rear sealed door (51) are respectively connected with a cylinder, which provides power for opening and closing doors.

5. A front and back spot gluing and solidifying machine for earphone MLB parts according to claim 1, wherein the turnover module (60) comprises:
No. 2 motor (61), arranged in the upper part of the No. 1 rack (10);
a clamping mechanism module (62), to which the No. 2 motor (61) is connected.

6. A front and back spot gluing and solidifying machine for earphone MLB parts according to claim 1, wherein the gluing module (20) comprises:
a straightening press module (21), disposed in the upper part of the No. 2 rack (112);
a syringe module (22), arranged on one side of the straightening press module (21);
a residual glue-erasing module (23), arranged on one side of the syringe module (22);
a spot gluing positioning module (24), disposed on one side of the residual glue-erasing module (23);
a height measurement system (25), used to measure the height of the product;
a CCD system (26), used to measure the position of the product;
a three-axis spot gluing rack (27), arranged on one side of the spot gluing positioning module (24).

7. A front and back spot gluing and solidifying machine for earphone MLB parts according to claim 1, wherein the No. 2 UV module (40) comprises:
No. 2 sealed cover (42), provided in the upper part of the No. 2 rack (112);
No. 2 front sealed door (43), set on one side of the No. 2 sealed cover (42);
No. 2 rear sealed door (41), set on the other side of the No. 2 sealed cover (42);
wherein the No. 2 front sealed door (43) and No. 2 rear sealed door (41) are respectively connected with a cylinder, which provides power for opening and closing doors.

8. A front and back spot gluing and solidifying machine for earphone MLB parts according to claim 1, wherein it further comprises:
No. 1 fan (18) disposed on the No. 1 rack (10) and used for exhaust cooling and a compressed gas switch valve (11) for controlling gas discharge;
No. 2 fan (14) disposed on the No. 2 rack (112) and used for exhaust cooling and a compressed gas switch valve (19) for controlling gas discharge.

9. A front and back spot gluing and solidifying machine for earphone MLB parts according to claim 1, wherein it further comprises:
No. 2 man-machine interface (114) set on the No. 1 enclosure (110):
No. 1 man-machine interface (113) set on the No. 2 enclosure (111).
